(19) United States
(12) Patent Application Publication
(10) Pub. No.: US 2005/0044297 A1
(43) Pub. Date: Feb. 24, 2005

(54) Memory device operable with a plurality of protocols

(76) Inventor: Eugene Feng, San Jose, CA (US)

Correspondence Address: GRAY CARY WARE & FREIDENRICH LLP, 2000 UNIVERSITY AVENUE, E. PALO ALTO, CA, 94303-2248, US

(21) Appl. No.: 10/643,622

(22) Filed: Aug. 18, 2003

(51) Int. Cl. G06F 3/00; G06F 12/00

(52) U.S. Cl. 710/104; 711/170

(57) ABSTRACT

An improved memory device is operable in a plurality of modes. The improved memory device has an interface logic decoding circuit which decodes the signals on the communication bus with the external integrated circuit. Depending upon the decoded signals from the communication bus, the memory device is operable in one of the plurality of protocol modes. In particular, one of the applications of the improved memory device is to operate in either the LPC or the FWH communication protocol.

### TECHNICAL FIELD

The present invention relates to a memory device which can interface and operate with a plurality of protocols and more particularly to a non-volatile memory device which can be used with a plurality of different protocols such as LPC and FWH protocols.

### BACKGROUND OF THE INVENTION

Computer systems are well known in the art. In particular, a computer system adhering to the “IBM PC” standard is well known in the art. Referring to FIG. 1, there is shown a computer system 10 of the prior art. The computer system 10 conforms to the “IBM PC” architecture. The system 10 comprises typically a motherboard 12 on which are mounted a variety of components such as a processor 14, such as a Pentium microprocessor made by Intel Corporation, a memory controller hub (MCH) chip 16, and a 10 controller hub (ICH) chip 18. The MCH 16 and the ICH 18 are known as chipsets and can be obtained from Intel Corporation. Finally, the motherboard 12 comprises a BIOS 20 which is typically a non-volatile memory device. The foregoing system is described and is disclosed in U.S. Pat. No. 6,421,765. See also U.S. Pat. No. 6,330,635.

Intel Corporation, a developer of the MCH chip 16, also developed the ICH chip 18 which has a particular feature known as a low pin count (LPC) bus. See, for example, U.S. Pat. No. 5,991,841. The LPC bus communicates between the ICH chip 18 and the BIOS 20. At the time that Intel Corporation introduced the LPC bus 30, it disclosed that the LPC bus 30 is operable in accordance with the standard as disclosed in FIG. 2. This is also disclosed in U.S. Pat. No. 5,911,841. The LPC bus 30 comprises four signal lines between the ICH chip 18 and the peripheral devices such as the BIOS memory device 20. Along the four signal lines, designated as LAD [3:0], are supplied command, data and address signals. As shown in FIG. 2, the initial field for the LAD bus is a start field. This is then followed by the address and the data signals.

Initially, when Intel Corporation opened or disclosed the format of the LPC bus 30, it disclosed to the public that the ICH chip 18 is operable with a memory device 20 only in accordance with the FWH protocol. Thus, Intel disclosed that when the LAD [3:0] signals had the bit pattern of “1101” or “1110” in the start field, then that represents communication with a BIOS memory device 20.

At the time that Intel announced the FWH protocol for the ICH chip 18, other semiconductor chip makers also made and sold chipsets, such as the combination of MCH chip 16 and ICH chip 18 that communicate in the LPC protocol. However, these chipset makers established a protocol in which the start field having the bit pattern of “0000” would mean the start of a cycle for the BIOS memory device 20. Thus, to a manufacturer and supplier of a BIOS memory device 20, the manufacturer must maintain two sets of inventory: one set of memory device 20 that is operable under the FWH protocol for Intel and another set of memory devices 20 that are operable with the LPC protocol from other chipset makers. It should be noted that the difference in operation between the LPC protocol and the FWH protocol is well known in the art. For example, the address field and select field are handled slightly differently in the LPC and FWH as well as the decoding of these. In the FWH protocol, there are four (4) bits of the IDSEL field and 28 bit address field. In the LPC protocol there are 32 bit address field with IDSEL included.

On Aug. 20, 2002, Intel announced that its ICH chip 18 would be able to operate with a BIOS memory device 20 with either the FWH protocol or the LPC protocol. For the manufacturer of the BIOS memory device 20, having a memory device which is operable in two protocols would eliminate the inventory problem.

Hence, this is one of the objectives of the present invention.

### SUMMARY OF THE INVENTION

In the present invention, a memory device for interfacing with an integrated circuit communicates via a communication bus. The device comprises a decoding circuit for receiving the communication signals received via the communication bus. The decoding circuit further decodes the communication signals and generates a plurality of protocol signals in response thereto. A protocol select circuit receives the plurality of protocol signals. The memory device further comprises an array of memory cells. A control circuit controls the operation of the array of memory cells. Finally, the protocol select circuit configures the controller circuit in response to the plurality of protocol signals.

### BRIEF DESCRIPTION OF THE DRAWINGS

FIG. 1 is a block diagram view of a computer system in accordance with the “IBM PC” architecture of the prior art.

FIG. 2 is a timing diagram showing the protocol of communication between the ICH chip 18 and the BIOS memory device 20 in accordance with the computer system shown in FIG. 1.

FIG. 3 is a block diagram of the dual protocol memory device of the present invention operable with the ICH chip 18 over an LPC bus 30.

FIG. 4 is a block level diagram of the bus interfacing logic circuit portion of the dual protocol memory device of the present invention.

FIG. 5 is a detailed schematic diagram of the circuit shown in FIG. 4.

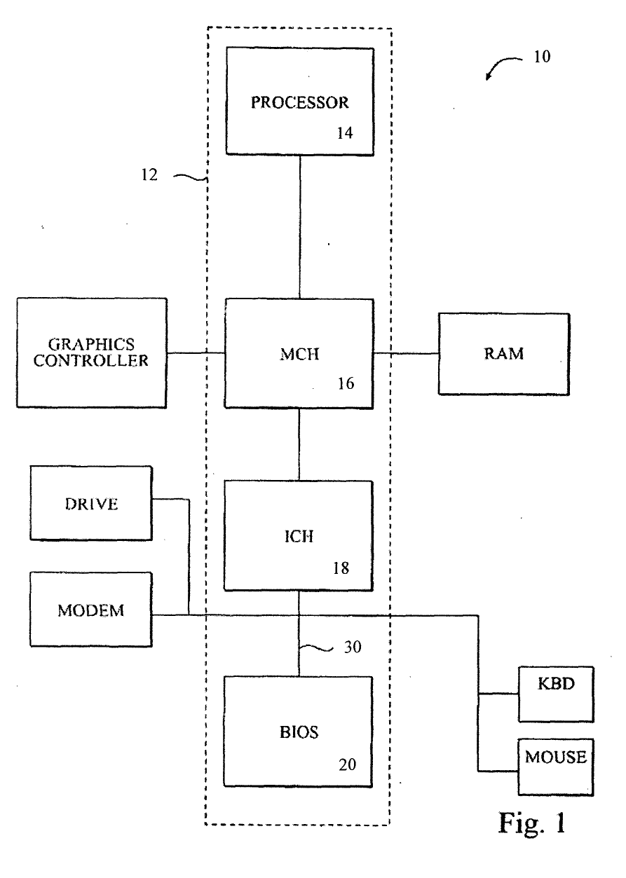

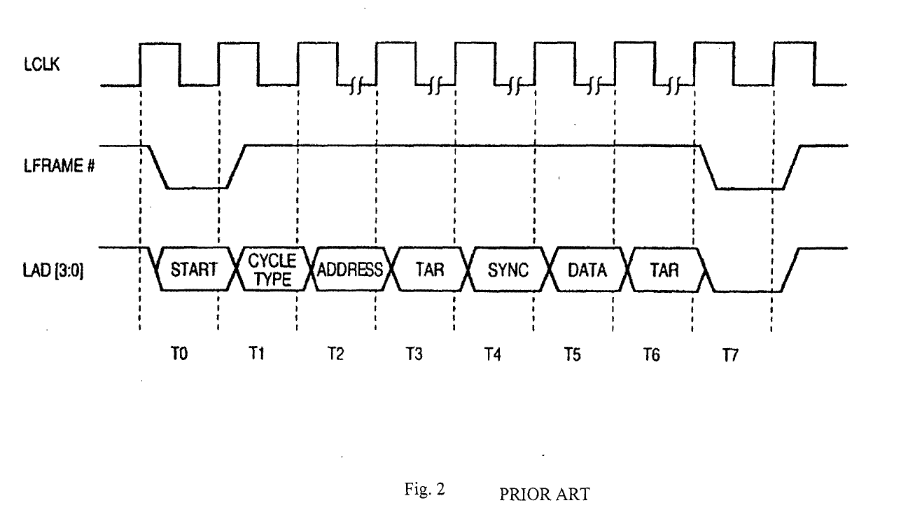

### DETAILED DESCRIPTION OF THE INVENTION

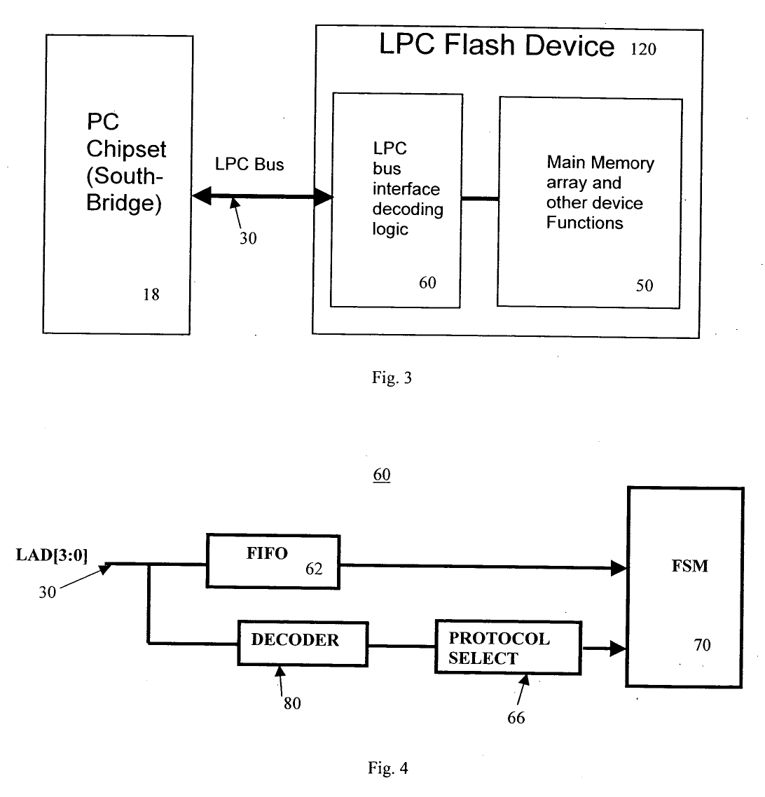

Referring to FIG. 3, there is shown an improved memory device 120 of the present invention. The improved memory device 120 is capable of operating via an LPC bus 30 with either a chipset 18 that is communicating in the LPC protocol or the FWH protocol. The improved memory device 120 similar to the BIOS memory device 20 of the prior art has a main memory array and other device function 50 which typically consists of an array of non-volatile memory cells. The improvement to the memory device 120 of the present invention is in the interfacing logic circuit 60, which interfaces with the LPC bus 30 and in particular the LAD [3:0] signals of the LAD bus or the communication bus 30.

Referring to FIG. 4, there is shown a block level diagram of the interface decoding logic circuit 60. The interface decoding logic circuit 60 comprises a FIFO or any other kind of delay memory 62 which receives the bus signals from the LAD bus. The decoding logic circuit 60 also comprises a decoder circuit 80 which also interfaces with the LAD or communication bus. The decoder circuit 80 receives the signals from the start field of the LAD bus and generates output signals which are supplied to a protocol select circuit 66. The output of the protocol select circuit 66 is then supplied to a finite state machine 70 or a controller which controls the non-volatile memory cells of the main memory array 50. The output of the FIFO 62 or other memory delay circuits is supplied to the finite state machine circuit 70.

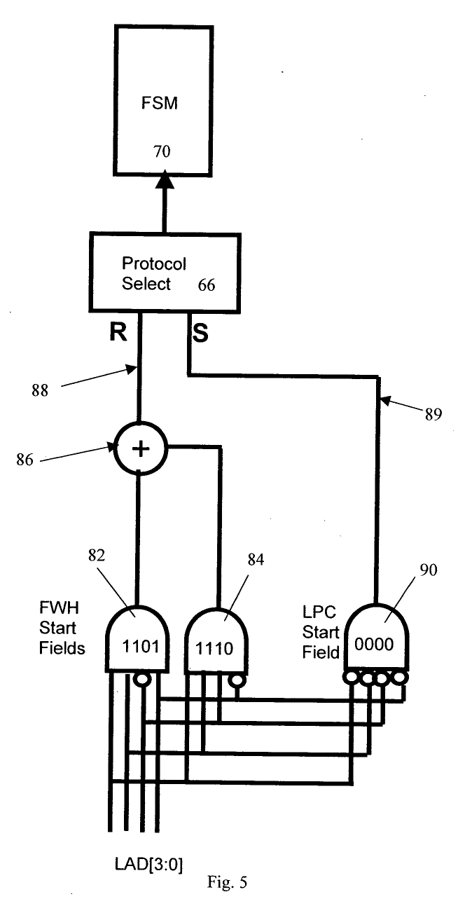

Referring to FIG. 5, there is shown in greater detail the decoding logic circuit 60. The LAD communication bus which is four signal lines are supplied to a first logic circuit 82, a second logic circuit 84, and a third logic circuit 90. The difference between the first, second, and third logic circuits 82, 84 and 90, respectively, is the manner in which the logic circuit decodes the signals from the LAD communication bus. The first decode logic circuit 82 is an AND logic circuit that receives the signal “xxyx” where x is a signal from the LAD communication bus 30 and y is the inverse of the signal from the LAD communication bus 30. Thus, in the event the start field has the bit pattern “1101” the output of the first logic decoding circuit 82 is a “1”. Similarly, the second logic decoding circuit 84 is an AND logic circuit that receives the bit pattern of “xxxy” where again x is the signal from the LAD communication bus 30 and y is the inverse of the signal from the LAD communication bus 30. Thus, if the bit pattern in the start field is “1110”, then the output of the second logic decoding circuit 84 is a bit pattern of “1”. The first logic decoding circuit 82 and the second logic decoding circuit 84 are supplied to an OR gate 86 which produces an output 88 which is supplied to the protocol select circuit 66. The output 88 is the reset signal and is high or “1” if the start field is either the bit pattern of “1101” or “1110”, either of which signifies that it is operable in the FWH protocol.

The LAD communication bus 30 is also supplied to the third logic decoding circuit 90. The third logic decoding circuit 90 is also an AND logic circuit that receives the signals “yyyy” in which y is the inverse of the signal from the LAD communication bus 30. Thus, if the start field in the LAD communication bus 30 is “0000”, the output of the third logic decoding circuit 90 is a “1”. This signifies that the ICH 18 is operable in the “LPC” protocol mode. The output of the third logic decoding circuit 90, which is the set signal 89, is supplied to the protocol select circuit 66. Thus, the reset signal 88 or the select signal 89 is supplied to the protocol select circuit 66. The protocol select signal 66 in one embodiment can be a flip flop or register, or any other volatile storage element, such as an SRAM, in which the reset signal 88 or the set signal 89 “flips” or “sets” or “resets” the protocol select circuit 66 into one of two possible states. Based upon the possible state selected or set by the reset or the set signals, the protocol select circuit 66 then controls the finite state machine 70. The finite state machine circuit 70 is operable in one of two modes. Each of the modes is determined by the output of the protocol select circuit 66. As a result of the protocol select circuit 66, the finite state machine 70 would operate the memory array 50 in one of the two possible protocol modes.

From the foregoing it can be seen that with the improved memory device 120 of the present invention, a single memory device can be used with a plurality of chipsets operable in a plurality of different protocol modes. The manufacturer of the memory device 120 would then need to maintain only one inventory of the products.

1. A memory device for interfacing with an integrated circuit communicating via a communication bus, said device comprising:
a decoding circuit for receiving communication signals received via the communication bus, for decoding the communication signals and for generating a plurality of protocol signals in response thereto;
a protocol select circuit for receiving said plurality of protocol signals;
an array of memory cells;
a controller circuit for controlling the operation of said array of memory cells;
said protocol select circuit for configuring the controller circuit in response to the plurality of protocol signals.

2. The device of claim 1 wherein said memory cells are non-volatile memory cells.

3. The device of claim 2 wherein said protocol select circuit is a volatile storage element.

4. The device of claim 3 wherein said volatile storage element is a register.

5. The device of claim 3 wherein said volatile storage element is a flip-flop.

6. The device of claim 3 wherein said volatile storage element is an SRAM.

7. A memory device for interfacing with an integrated circuit communicating via an LPC bus, said circuit generating a start field, said device comprising:
a decoding circuit for receiving the start field and for generating a plurality of protocol signals;
a protocol select circuit for receiving said plurality of protocol signals;
an array of non-volatile memory cells;
a controller circuit for controlling the operation of said array of non-volatile memory cells;
said protocol select circuit for configuring the controller circuit in response to the plurality of protocol signals.

8. The device of claim 7 wherein said protocol select circuit is a flip-flop.

9. The device of claim 7 wherein said plurality of protocol signals represent protocol for LPC communication and for FWH communication.
